(19) United States
(12) Patent Application Publication
(10) Pub. No.: US 2024/0152136 A1
(43) Pub. Date: May 9, 2024

(54) VEHICLE REMOTE CONTROL SYSTEM AND OPERATION METHOD THEREOF

(71) Applicant: WISTRON NEWEB CORPORATION, HSINCHU (TW)

(72) Inventor: CHIA-HSIN WU, HSINCHU (TW)

(21) Appl. No.: 18/451,165

(22) Filed: Aug. 17, 2023

(30) Foreign Application Priority Data
Nov. 9, 2022 (TW) 111142684

(51) Int. Cl. G05D 1/00; H01Q 1/32; H04B 17/318; H04W 4/40

(52) U.S. Cl. CPC G05D 1/0022; H01Q 1/325; H04B 17/318; H04W 4/40; G05D 2201/0213

(57) ABSTRACT

A vehicle remote control system and an operation method thereof are provided. The vehicle remote control system includes a wireless signal processing circuit, a first antenna, a switch device, a signal transmission line, and a second antenna. The switch device is connected to the first antenna and one end of the signal transmission line. Another end of the signal transmission line is connected to the second antenna. When the switch device is in a first state, the wireless signal processing circuit reads a first signal of a remote controller received by the first antenna to calculate first state information. When the switch device is in a second state, the wireless signal processing circuit reads a second signal of the remote controller received by the second antenna to calculate second state information.

### CROSS-REFERENCE TO RELATED PATENT APPLICATION

This application claims the benefit of priority to Taiwan Patent Application No. 111142684, filed on Nov. 9, 2022. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a remote control system and an operation method thereof, and more particularly to a vehicle remote control system and an operation method thereof.

### BACKGROUND OF THE DISCLOSURE

Motorcycles that adopt wireless keys have become more and more popular on the market. The wireless key of the motorcycle includes a transmitting antenna, and the motorcycle includes a receiving antenna and a processor. When the processor determines that energy of a radio frequency (RF) signal from the wireless key is greater than or equal to a threshold value, this indicates that the wireless key is located near the motorcycle, so that the motorcycle is unlocked. Conversely, when the processor determines that the energy of the radio frequency signal from the wireless key is less than the threshold value, the motorcycle is locked.

However, when an obstacle (such as a human body or a wall) is located between the wireless key and the motorcycle, the energy of the RF signal sent by the wireless key is affected and reduced by the obstacle. The higher a frequency of the RF signal is, the more significant the decrease in the energy of the RF signal is. As a result, the processor of the motorcycle is prone to misjudgment and often cannot unlock or lock the motorcycle at a correct time point.

### SUMMARY OF THE DISCLOSURE

In response to the above-referenced technical inadequacies, the present disclosure provides a vehicle remote control system and an operation method thereof.

In order to solve the above-mentioned problems, one of the technical aspects adopted by the present disclosure is to provide a vehicle remote control system. The vehicle remote control system is adapted to a remote controller and a vehicle, and the vehicle remote control system includes a wireless signal processing circuit, a first antenna, a switch device, a signal transmission line, and a second antenna. The switch device is connected to the first antenna and the wireless signal processing circuit. A first end and a second end of the signal transmission line are electrically connected to the switch device and the second antenna, respectively. According to a switch instruction of the wireless signal processing circuit, the switch device allows one of the first antenna and the second antenna to be used in a switching manner. The wireless signal processing circuit obtains first state information between the remote controller and the vehicle by the first antenna and obtains second state information between the remote controller and the vehicle by the second antenna.

In order to solve the above-mentioned problems, another one of the technical aspects adopted by the present disclosure is to provide an operation method of a vehicle remote control system. The operation method is adapted to a remote controller and a motorcycle. The operation method includes: obtaining, by a first antenna, a first signal of the remote controller; reading, by a wireless signal processing circuit, the first signal to calculate first state information between the remote controller and the vehicle; performing, by a switch device, an antenna switching action; obtaining, by a second antenna, a second signal of the remote controller, wherein, the first antenna and the second antenna are respectively located at a head area and a rear area of the motorcycle; and reading, by the wireless signal processing circuit, the second signal to calculate second state information which is between the remote controller and the vehicle.

Therefore, in the vehicle remote control system and the operation method thereof provided by the present disclosure, a signal dead zone of the remote controller can be reduced by at least two antennas installed on the vehicle, and the wireless signal processing circuit is prevented from misjudging a signal transmitted from the remote controller.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a functional block diagram of a vehicle remote control system according to a first embodiment of the present disclosure;

FIG. 2A and FIG. 2B are flowcharts of an operation method of the vehicle remote control system according to the first embodiment of the present disclosure;

FIG. 3A to FIG. 3C are flowcharts of the operation method of the vehicle remote control system according to a second embodiment of the present disclosure;

FIG. 4 is a functional block diagram of the vehicle remote control system according to the second embodiment of the present disclosure;

FIG. 5A and FIG. 5B are flowcharts of the operation method of the vehicle remote control system according to a third embodiment of the present disclosure;

FIG. 6A to FIG. 6C are flowcharts of the operation method of the vehicle remote control system according to a fourth embodiment of the present disclosure; and

FIG. 7A and FIG. 7B are flowcharts of the operation method of the vehicle remote control system according to a fifth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like. In addition, the term “connect” in the context of the present disclosure means that there is a physical connection between two elements, and the two elements are directly or indirectly connected.

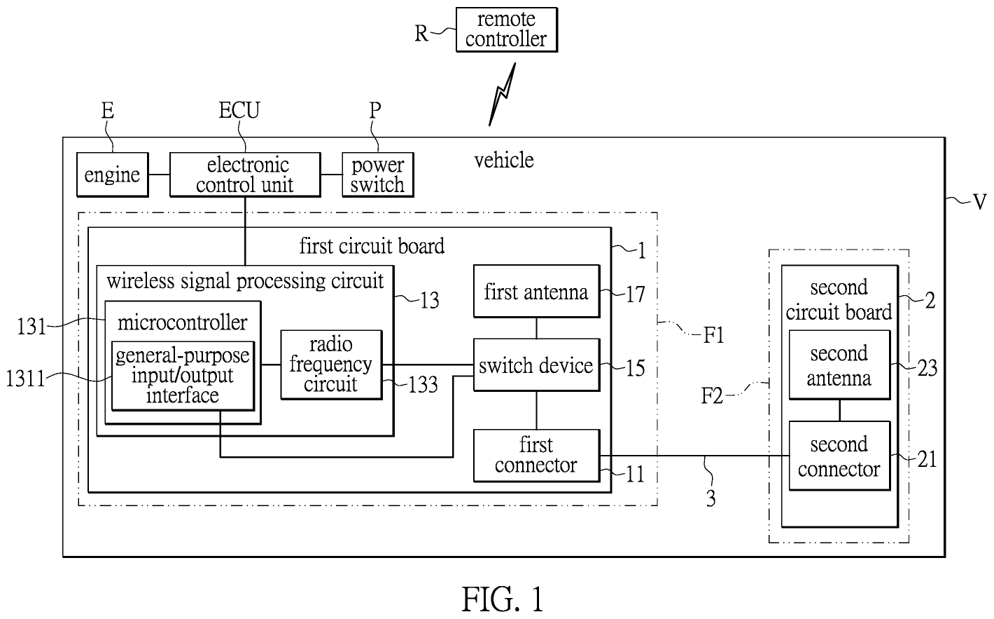

FIG. 1 is a functional block diagram of a vehicle remote control system according to a first embodiment of the present disclosure. Referring to FIG. 1, the vehicle remote control system is adapted to a remote controller R and a vehicle V. The remote controller R includes a motion sensor and an antenna (not shown in FIG. 1). When the motion sensor senses a movement of the remote controller R, the antenna of the remote controller R sends a radio frequency signal to the vehicle V. The vehicle V includes an electronic control unit ECU, and the electronic control unit ECU is used to detect statuses of vehicle components of vehicle and control the vehicle components according to the statuses of the vehicle components. The electronic control unit ECU includes an engine control unit and a power switch control unit, and the vehicle components include a power switch P and an engine E. In this embodiment, the electronic control unit ECU is electrically connected to the power switch P and the engine E. When the power switch is turned on, a vehicle battery can supply power to other vehicle components of the vehicle. When the power switch is turned off, the vehicle battery cannot supply power to other vehicle components.

The vehicle remote control system includes a first circuit board 1, a second circuit board 2, and a signal transmission line 3. The first circuit board 1 is disposed in a first area F1 of the vehicle V, and a first connector 11 is disposed on the first circuit board 1. The second circuit board 2 is disposed in a second area F2 of the vehicle V, and a second connector 21 is disposed on the second circuit board 2. A distance is defined between the first area F1 and the second area F2, and a first end and a second end of the signal transmission line 3 are connected to the first connector 11 and the second connector 21, respectively. A length of the signal transmission line 3 can be, for example, between 1.5 meters and 2 meters, but is not limited thereto.

A wireless signal processing circuit 13, a switch device 15, and a first antenna 17 are also disposed on the first circuit board 1. The wireless signal processing circuit 13 is connected to the electronic control unit ECU, and can be, for example, a BLUETOOTH® communication circuit. The wireless signal processing circuit 13 includes a microcontroller 131 and a radio frequency circuit 133, and the microcontroller 131 is electrically connected to the radio frequency circuit 133. The radio frequency circuit 133 is used for processing a radio frequency signal that ranges between 2 GHz and 2.4 GHz. The microcontroller 131 receives radio frequency signals from the first antenna 17 and a second antenna 23 by the radio frequency circuit 133. The microcontroller 131 includes a general-purpose input/output (GPIO) interface 1311, and sends a switch instruction to the switch device 15 by the general-purpose input/output interface 1311. For example, the vehicle can be a motorcycle, and the first area F1 and the second area F2 are respectively a head area and a rear area of the motorcycle. Therefore, the first antenna 17 and the second antenna 23 are respectively located at the head area and the rear area of the motorcycle.

The wireless signal processing circuit 13 is electrically connected to a bus interface of the electronic control unit ECU. For example, when the electronic control unit ECU of the vehicle V senses the status of the engine, the electronic control unit ECU reports the status of the engine to the wireless signal processing circuit 13 by the bus interface. When the wireless signal processing circuit 13 determines the status of the engine, the wireless signal processing circuit 13 instructs the electronic control unit ECU to start or turn off the engine.

When the electronic control unit ECU of the vehicle V detects the status of the power switch, the electronic control unit ECU reports the status of the power switch to the wireless signal processing circuit 13 by the bus interface. When the wireless signal processing circuit 13 determines the status of the power switch, the wireless signal processing circuit 13 instructs the electronic control unit ECU to start or turn off the power switch.

The switch device 15 is electrically connected to the first connector 11, the radio frequency circuit 133, the general-purpose input/output interface 1311, and the first antenna 17. The first antenna 17 is a first BLUETOOTH® antenna. The second antenna 23 is also disposed on the second circuit board 2, and is electrically connected to the second connector 21. The second antenna 23 is a second BLUETOOTH® antenna.

The switch device 15 includes a first state and a second state, and the switch 15 device is in the first state or the second state according to the switch instruction from the microcontroller 131.

When the switch device 15 is in the first state, a first signal transmission path between the first antenna 17 and the wireless signal processing circuit 13 is in a conductive state, and a second transmission path between the second antenna 23 and the wireless signal processing circuit 13 is in a non-conductive state. Conversely, when the switch device 15 is in the second state, the first signal transmission path between the first antenna 17 and the wireless signal processing circuit 13 is in the non-conductive state, and the second signal transmission path between the second antenna 23 and the wireless signal processing circuit 13 is in the conductive state.

In the embodiment of FIG. 1, the wireless signal processing circuit 13 is the BLUETOOTH® communication circuit. In other embodiments of the present disclosure, the wireless signal processing circuit 13 can be an ultra-wideband communication circuit, such that the first antenna 17 and the second antenna 19 are respectively a first ultra-wideband antenna and a second ultra-wideband antenna. The radio frequency circuit 133 is used for processing a radio frequency signal that ranges between 4 GHz and 6 GHz.

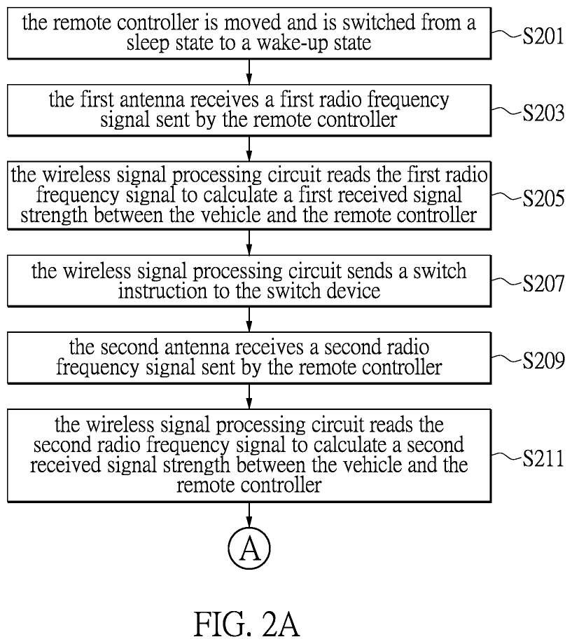

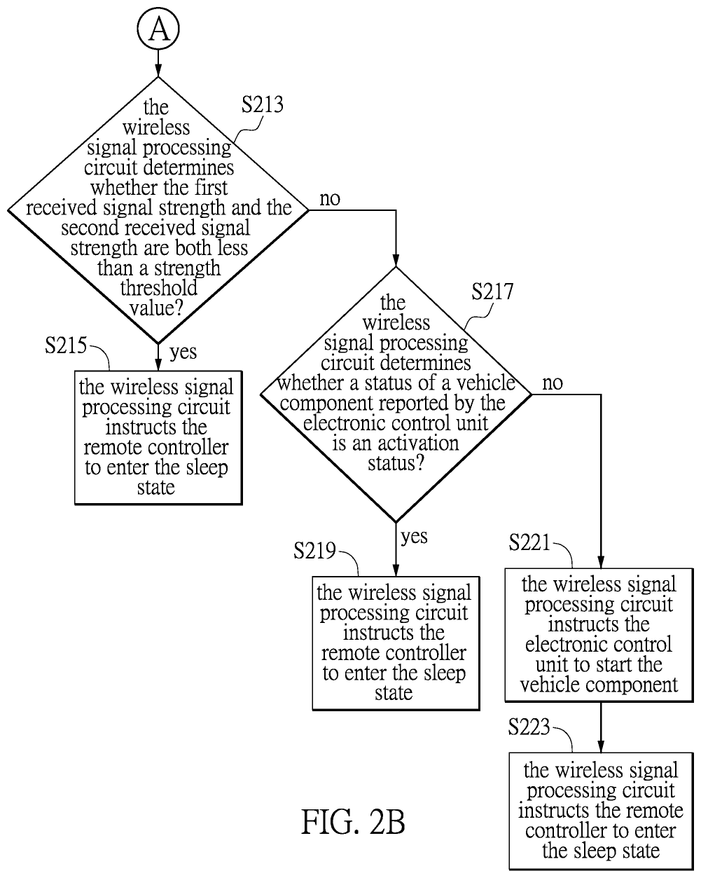

FIG. 2A and FIG. 2B are flowcharts of an operation method of the vehicle remote control system according to the first embodiment of the present disclosure. The operation method of FIG. 2A and FIG. 2B can be implemented by the vehicle remote control system of FIG. 1, but is not limited thereto.

Referring to FIG. 2A, in step S201, the remote controller R is moved and is switched from a sleep state to a wake-up state. For example, when the remote controller R is in the sleep state, only a motion sensor of the remote controller R is enabled. A radio frequency circuit of the remote controller is disabled, and a microcontroller of the remote controller R is in low power mode. When the remote controller R is in the wake-up mode, the motion sensor wakes up the microcontroller, and the microcontroller enables the radio frequency circuit.

In step S203, the first antenna 17 receives a first radio frequency signal sent by the remote controller R. In step S205, the wireless signal processing circuit 13 reads the first radio frequency signal to calculate a first received signal strength between the vehicle V and the remote controller R. In step S207, the wireless signal processing circuit 13 sends a switch instruction to the switch device 15. In step S209, the second antenna 23 receives a second radio frequency signal sent by the remote controller R. In step S211, the wireless signal processing circuit 13 reads the second radio frequency signal to calculate a second received signal strength between the vehicle V and the remote controller R.

Referring to FIG. 2B, in step S213, the wireless signal processing circuit 13 determines whether the first received signal strength and the second received signal strength are both less than a strength threshold value. When both of the first received signal strength and the second received signal strength are less than the strength threshold value, step S213 is followed by step S215. When at least one of the first received signal strength and the second received signal strength is greater than or equal to the strength threshold value, step S213 is followed by step S217.

In step S215, the wireless signal processing circuit 13 instructs the remote controller R to enter the sleep state. In step S217, the wireless signal processing circuit 13 determines whether a status of a vehicle component reported by the electronic control unit ECU is an activation status.

When the wireless signal processing circuit 13 determines that the status of the vehicle component is the activation status, step S217 is followed by step S219. When the wireless signal processing circuit 13 determines that the status of the vehicle component is not the activation status, step S217 is followed by step S221. In step S219, the wireless signal processing circuit 13 instructs the remote controller R to enter the sleep state. In step S221, the wireless signal processing circuit 13 instructs the electronic control unit ECU to start the vehicle component. Then, step S221 is followed by step S223. In step S223, the wireless signal processing circuit 13 instructs the remote controller R to enter the sleep state.

Regarding the operation method of FIG. 2A and FIG. 2B, a practical example is illustrated below. The first BLUETOOTH® antenna and the second BLUETOOTH® antenna are respectively disposed in a head area and a rear area of a motorcycle. The first BLUETOOTH® antenna receives the first radio frequency signal from the remote controller at a first time point, and the BLUETOOTH® communication circuit reads the first radio frequency signal to calculate the first received signal strength between the motorcycle and the remote controller. The second BLUETOOTH® antenna receives the second radio frequency signal from the remote controller at a second time point, and the BLUETOOTH® communication circuit reads the second radio frequency signal to calculate the second received signal strength between the motorcycle and the remote controller. The BLUETOOTH® communication circuit determines whether the first received signal strength and the second received signal strength are both less than −51 dBm. When the first received signal strength and the second received signal strength are both less than −51 dBm, the BLUETOOTH® communication circuit instructs the remote controller to enter the sleep state. When at least one of the first received signal strength and the second received signal strength is greater than or equal to −51 dBm, the BLUETOOTH® communication circuit checks whether the power switch P or the engine E of the motorcycle is started. When the power switch P or the engine E of the motorcycle is started, the BLUETOOTH® communication circuit instructs the remote controller to enter the sleep state. When the power switch P or the engine E of the motorcycle is not started, the BLUETOOTH® communication circuit instructs the electronic control unit ECU to activate the power switch.

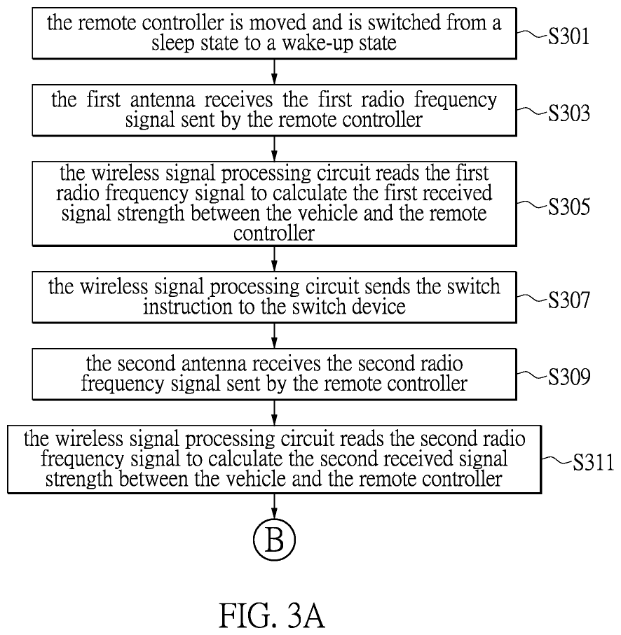

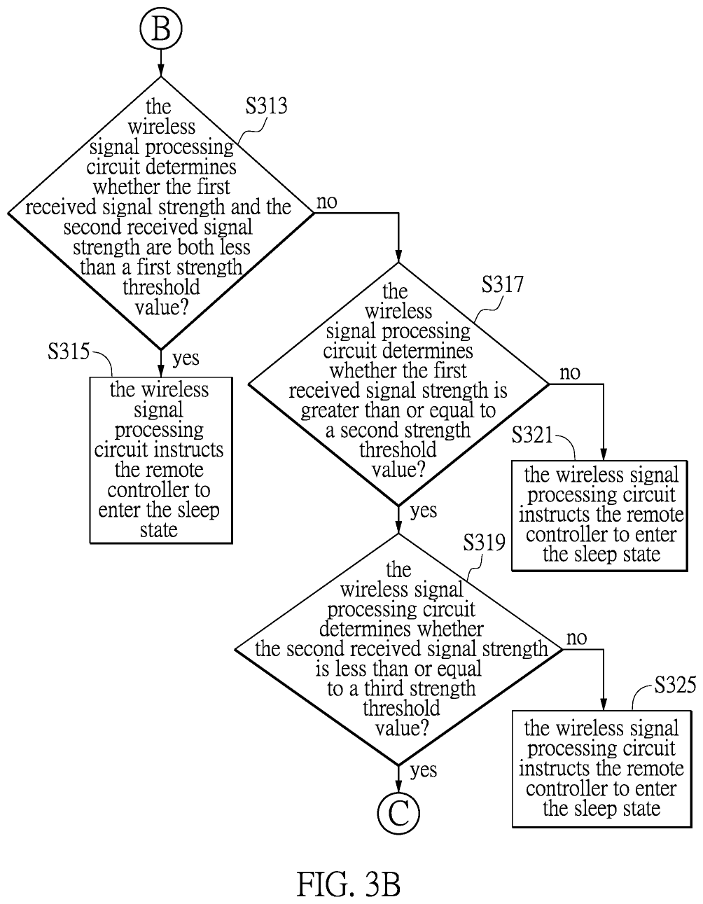

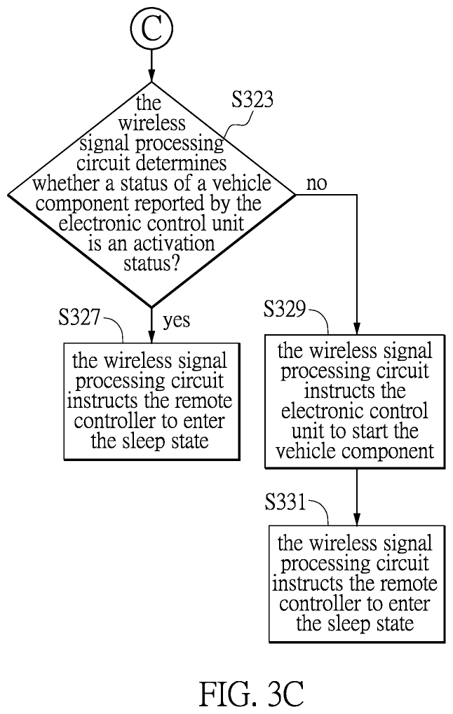

FIG. 3A to FIG. 3B are flowcharts of the operation method of the vehicle remote control system according to a second embodiment of the present disclosure. The operation method of FIG. 3A to FIG. 3C can be implemented by the vehicle remote control system of FIG. 1, but is not limited thereto.

Referring to FIG. 3A, in step S301, the remote controller R is moved and is switched from a sleep state to a wake-up state. In step S303, the first antenna 17 receives the first radio frequency signal sent by the remote controller R. In step S305, the wireless signal processing circuit 13 reads the first radio frequency signal to calculate the first received signal strength between the vehicle V and the remote controller R. In step S307, the wireless signal processing circuit 13 sends the switch instruction to the switch device 15. In step S309, the second antenna 23 receives the second radio frequency signal sent by the remote controller R. In step S311, the wireless signal processing circuit 13 reads the second radio frequency signal to calculate the second received signal strength between the vehicle V and the remote controller R.

Referring to FIG. 3B, in step S313, the wireless signal processing circuit 13 determines whether the first received signal strength and the second received signal strength are both less than a first strength threshold value. When both of the first received signal strength and the second received signal strength are less than the first strength threshold value, step S313 is followed by step S315. When at least one of the first received signal strength and the second received signal strength is greater than or equal to the first strength threshold value, step S313 is followed by step S317.

In step S315, the wireless signal processing circuit 13 instructs the remote controller R to enter the sleep state. In step S317, the wireless signal processing circuit 13 determines whether the first received signal strength is greater than or equal to a second strength threshold value. When the first received signal strength is greater than or equal to the second strength threshold value, step S317 is followed by step S319. When the first received signal strength is less than the second strength threshold value, step S317 is followed by step S321.

In step S319, the wireless signal processing circuit 13 determines whether the second received signal strength is less than or equal to a third strength threshold value. Here, the second strength threshold value is greater than the first strength threshold value, and the first strength threshold value is greater than the second strength threshold value. In step S321, the wireless signal processing circuit 13 instructs the remote controller R to enter the sleep state.

When the second received signal strength is less than or equal to the third strength threshold value, step S319 is followed by step S323. When the second received signal strength is greater than the third strength threshold value, step S319 is followed by step S325.

Referring to FIG. 3B and FIG. 3C, in step S323, the wireless signal processing circuit 13 determines whether a status of a vehicle component reported by the electronic control unit ECU is an activation status. In step S325, the wireless signal processing circuit 13 instructs the remote controller R to enter the sleep state

Referring to FIG. 3C, when the wireless signal processing circuit 13 determines that the status of the vehicle component is the activation status, step S323 is followed by step S327. When the wireless signal processing circuit 13 determines that the status of the vehicle component is not the activation status, step S323 is followed by step S329. In step S327, the wireless signal processing circuit 13 instructs the remote controller R to enter the sleep state. In step S329, the wireless signal processing circuit 13 instructs the electronic control unit ECU to start the vehicle component. Then, step S329 is followed by step S331. In step S331, the wireless signal processing circuit 13 instructs the remote controller R to enter the sleep state.

Regarding the operation method of FIG. 3A to FIG. 3C, two practical examples are illustrated below. In a first practical example, the first BLUETOOTH® antenna and the second BLUETOOTH® antenna are respectively disposed in the head area and the rear area of the motorcycle and the remote controller R is located in a front pocket of a user. When the first BLUETOOTH® antenna receives the first radio frequency signal from the remote controller R at the first time point, the BLUETOOTH® communication circuit reads the first radio frequency signal to calculate the first received signal strength between the vehicle and the remote controller R. The second BLUETOOTH® antenna receives the second radio frequency signal from the remote controller R at the second time point, and the BLUETOOTH® communication circuit reads the second radio frequency signal to calculate the second received signal strength between the vehicle and the remote controller. The BLUETOOTH® communication circuit determines whether the first received signal strength and the second received signal strength are both less than −51 dBm. When the first received signal strength and the second received signal strength are both less than −51 dBm, the BLUETOOTH® communication circuit instructs the remote controller R to enter the sleep state. When at least one of the first received signal strength and the second received signal strength is greater than or equal to −51 dBm, the BLUETOOTH® communication circuit further determines whether the first received signal strength is greater than or equal to −35 dBm.

When the first received signal strength is greater than or equal to −35 dBm, the BLUETOOTH® communication circuit further determines whether the second received signal strength is less than or equal to −65 dBm. When the first received signal strength is less than −35 dBm, the BLUETOOTH® communication circuit instructs the remote controller R to enter the sleep state.

When the second received signal strength is less than or equal to −65 dBm, the BLUETOOTH® communication circuit determines whether the power switch P or the engine E of the motorcycle is started. When the second received signal strength is greater than −65 dBm, the BLUETOOTH® communication circuit instructs the remote controller R to enter the sleep state.

A second practical example is different from the first practical example in that the remote controller R is located in a back pocket or a backpack of the user. When at least one of the first received signal strength and the second received signal strength is greater than or equal to −51 dBm, the BLUETOOTH® communication circuit further determines whether the first received signal strength is less than or equal to −65 dBm. When the first received signal strength is less than or equal to −65 dBm, the BLUETOOTH® communication circuit further determines whether the second received signal strength is greater than or equal to −35 dBm. When the first received signal strength is greater than −65 dBm, the BLUETOOTH® communication circuit instructs the remote controller R to enter the sleep state. When the second received signal strength is greater than or equal to −35 dBm, the BLUETOOTH® communication circuit determines whether the power switch P or the engine E of the motorcycle is started. When the second received signal strength is less than −35 dBm, the BLUETOOTH® communication circuit instructs the remote controller R to enter the sleep state. The first and the second practical examples can be used to determine whether the user is located between two antennas. In other words, the first and the second practical examples can be used to determine whether the user sits on a seat of the motorcycle. When one of the antennas is blocked by the user's body, the received signal strength corresponding to the blocked antenna at least drops 30 dBm.

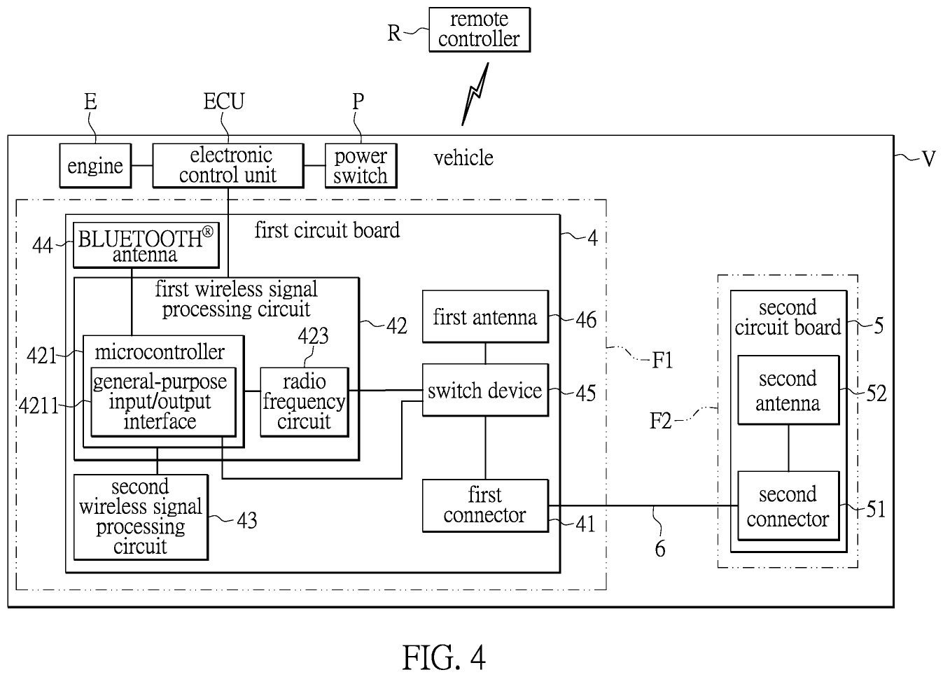

FIG. 4 is a functional block diagram of a vehicle remote control system according to the second embodiment of the present disclosure. Referring to FIG. 4, the vehicle remote control system is adapted to the remote controller R and the vehicle V. The vehicle remote control system includes a first circuit board 4, a second circuit board 5, and a signal transmission line 6. The first circuit board 4 is disposed in the first area F1 of the vehicle V, and a first connector 41 is disposed on the first circuit board 4. The second circuit board 5 is disposed in the second area F2 of the vehicle V, and a second connector 51 is disposed on the second circuit board 5. A first end and a second end of the signal transmission line 6 are connected to the first connector 41 and the second connector 51, respectively.

A first wireless signal processing circuit 42, a second wireless signal processing circuit 43, a BLUETOOTH® antenna 44, a switch device 45, and a first antenna 46 are also disposed on the first circuit board 4. The first wireless signal processing circuit 42 is connected to the electronic control unit ECU, and can be, for example, a BLUETOOTH® communication circuit. The second wireless signal processing circuit 43 can be, for example, an ultra-wideband communication circuit. The first antenna 46 can be, for example, a first ultra-wideband antenna.

The first wireless signal processing circuit 42 includes a microcontroller 421 and a radio frequency circuit 423, and the microcontroller 421 is electrically connected to the radio frequency circuit 423, the second wireless signal processing circuit 43, the BLUETOOTH® antenna 44, and the switch device 45. The radio frequency circuit 423 is electrically connected to the switch device 45.

For example, the microcontroller 421 sends an enabling signal to the second wireless signal processing circuit 43 according to a Serial Peripheral Interface (SPI) protocol.

The microcontroller 421 includes a general-purpose input/output interface 4211, and sends a switch instruction to the switch device 45 by the general-purpose input/output interface 4211.

The switch device 45 is electrically connected to the radio frequency circuit 423, the first connector 41, the general-purpose input/output interface 4211 of the microcontroller 421, the second wireless signal processing circuit 43, and the first antenna 46. A second antenna 52 is also disposed on the second circuit board 5, and is electrically connected to the second connector 51. The second antenna 52 can be, for example, a second ultra-wideband antenna.

For example, the vehicle can be a motorcycle, and the first area F1 and the second area F2 are respectively a head area and a rear area of the motorcycle. Therefore, the first antenna 46 and the second antenna 52 are respectively located at the head area and the rear area of the motorcycle.

The switch device 45 includes a first state and a second state, and the switch 45 is in the first state or the second state according to the switch instruction of the microcontroller 421.

When the switch 45 is in the first state, a first signal transmission path between the first antenna 46 and the second wireless signal processing circuit 43 is in a conductive state, and a second signal transmission path between the second antenna 52 and the second wireless signal processing circuit between 43 is in a non-conductive state. Conversely, when the switch device 45 is in the second state, the first signal transmission path between the first antenna 46 and the second wireless signal processing circuit 43 is in the non-conductive state, and the second signal transmission path between the second antenna 52 and the second wireless signal processing circuit 43 is in the conductive state.

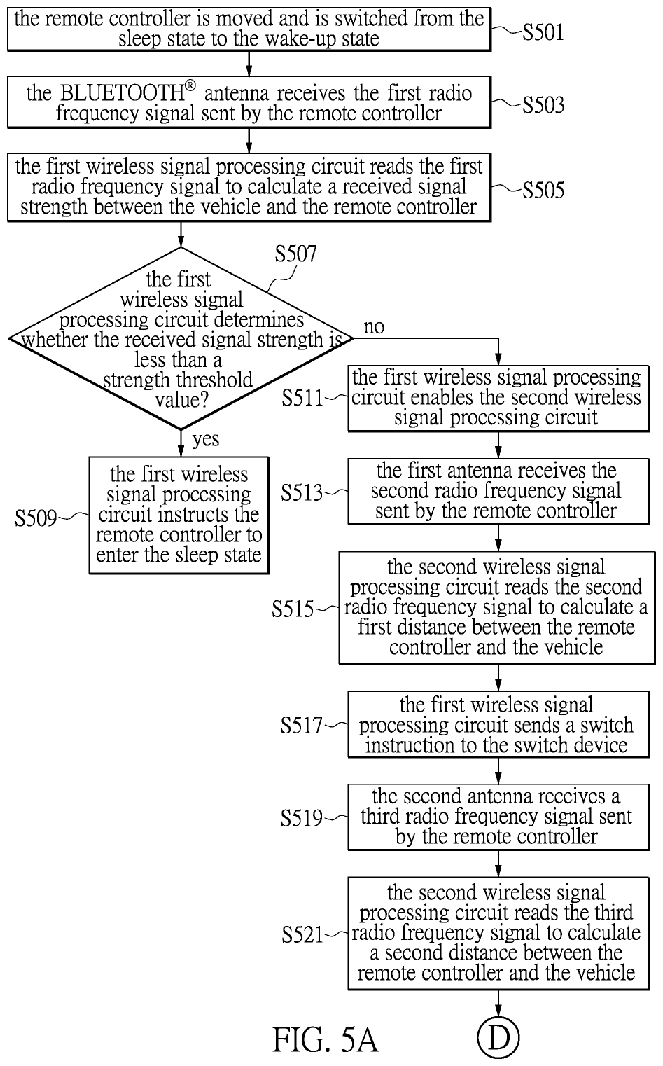

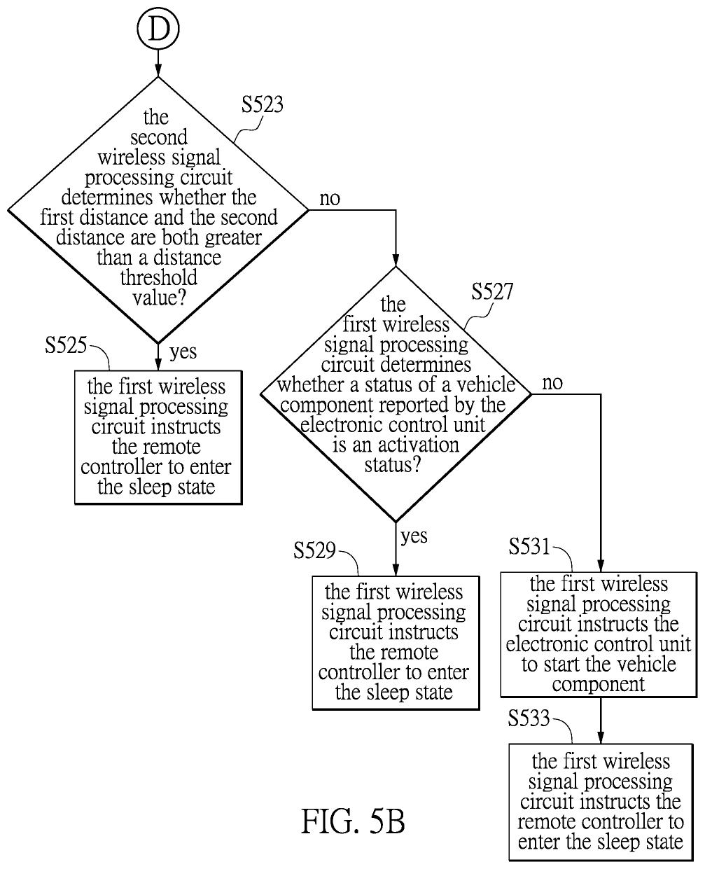

FIG. 5A and FIG. 5B are flowcharts of the operation method of the vehicle remote control system according to a third embodiment of the present disclosure. The operation method of FIG. 5A and FIG. 5B can be implemented by the vehicle remote control system of FIG. 4, but is not limited thereto.

Referring to FIG. 5A, in step S501, the remote controller R is moved and is switched from the sleep state to the wake-up state. In step S503, the BLUETOOTH® antenna 44 receives the first radio frequency signal sent by the remote controller R. In step S505, the first wireless signal processing circuit 42 reads the first radio frequency signal to calculate a received signal strength between the vehicle V and the remote controller R. In step S507, the first wireless signal processing circuit 42 determines whether the received signal strength is less than a strength threshold value. When the received signal strength is less than the strength threshold value, step S507 is followed by step S509. When the received signal strength is greater than or equal to the strength threshold value, step S507 is followed by step S511.

In step S509, the first wireless signal processing circuit 42 instructs the remote controller R to enter the sleep state. In step S511, the first wireless signal processing circuit 42 enables the second wireless signal processing circuit 43. In step S513, the first antenna 46 receives the second radio frequency signal sent by the remote controller R.

In step S515, the second wireless signal processing circuit 43 reads the second radio frequency signal to calculate a first distance between the remote controller R and the vehicle V. In step S517, the first wireless signal processing circuit 42 sends a switch instruction to the switch device 45. In step S519, the second antenna 52 receives a third radio frequency signal sent by the remote controller R. In step S521, the second wireless signal processing circuit 43 reads the third radio frequency signal to calculate a second distance between the remote controller R and the vehicle V.

Referring to FIG. 5B, in step S523, the second wireless signal processing circuit 43 determines whether the first distance and the second distance are both greater than a distance threshold value. When both of the first distance and the second distance are greater than the distance threshold value, step S523 is followed by step S525. When at least one of the first distance and the second distance is less than or equal to the distance threshold value, step S523 is followed by step S527.

In step S525, the first wireless signal processing circuit 42 instructs the remote controller R to enter the sleep state. More specifically, the second wireless signal processing circuit 43 reports information that the first distance and the second distance are both greater than the distance threshold value to the first wireless signal processing circuit 42. When the first wireless signal processing circuit 42 determines that the first distance and the second distance are both greater than the distance threshold value, the first wireless signal processing circuit 42 instructs the remote controller R to enter the sleep state.

In step S527, the first wireless signal processing circuit 42 determines whether a status of a vehicle component reported by the electronic control unit ECU is an activation status.

When the first wireless signal processing circuit 42 determines that the status of the vehicle component is the activation status, step S527 is followed by step S529. When the first wireless signal processing circuit 42 determines that the status of the vehicle component is not the activation status, step S527 is followed by step S531. In step S529, the first wireless signal processing circuit 42 instructs the remote controller R to enter the sleep state. In step S531, the first wireless signal processing circuit 42 instructs the electronic control unit ECU to start the vehicle component. Then, step S531 is followed by step S533. In step S533, the first wireless signal processing circuit 42 instructs the remote controller R to enter the sleep state.

Regarding the operation method of FIG. 5A and FIG. 5B, a practical example is illustrated below. The first BLUETOOTH® antenna and the first ultra-wideband antenna are disposed in the head area of the motorcycle, and the second ultra-wideband antenna is disposed in the rear area of the motorcycle. The first BLUETOOTH® antenna receives the first radio frequency signal from the remote controller at the first time point, and the BLUETOOTH® communication circuit reads the first radio frequency signal to calculate the received signal strength between the motorcycle and the remote controller. The BLUETOOTH® communication circuit determines whether the received signal strength is less than −71 dBm. When the received signal strength is less than −71 dBm, the BLUETOOTH® communication circuit instructs the remote controller to enter the sleep state. When the received signal strength is greater than or equal to −71 dBm, the BLUETOOTH® communication circuit enables the ultra-wideband communication circuit.

The first ultra-wideband antenna receives the second radio frequency signal from the remote controller at the second time point, and the ultra-wideband communication circuit reads the second radio frequency signal to calculate the first distance between the motorcycle and the remote controller. The BLUETOOTH® communication circuit sends the switch instruction to the switch device. The second ultra-wideband antenna receives the third radio frequency signal from the remote controller at a third time point, and the ultra-wideband communication circuit reads the third radio frequency signal to calculate the second distance between the motorcycle and the remote controller. The ultra-wideband communication circuit determines whether the first distance and the second distance are both greater than 91 cm. When both of the first distance and the second distance are greater than 91 cm, the BLUETOOTH® communication circuit instructs the remote controller to enter the sleep state. When at least one of the first distance and the second distance is less than or equal to 91 cm, the BLUETOOTH® communication circuit checks whether the power switch P or the engine E of the motorcycle is started.

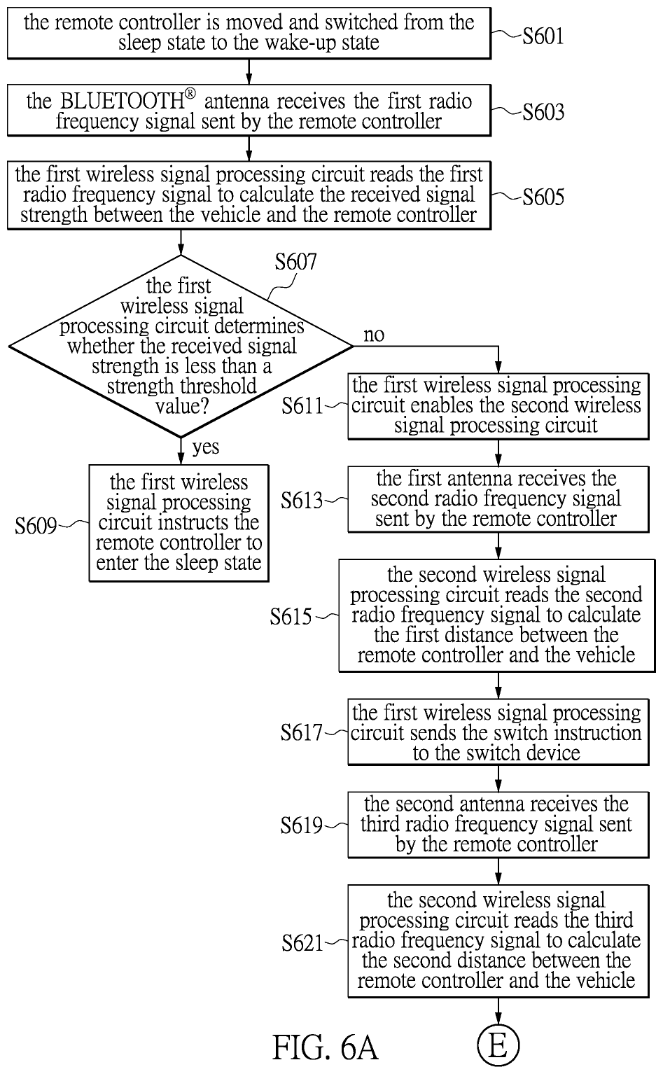

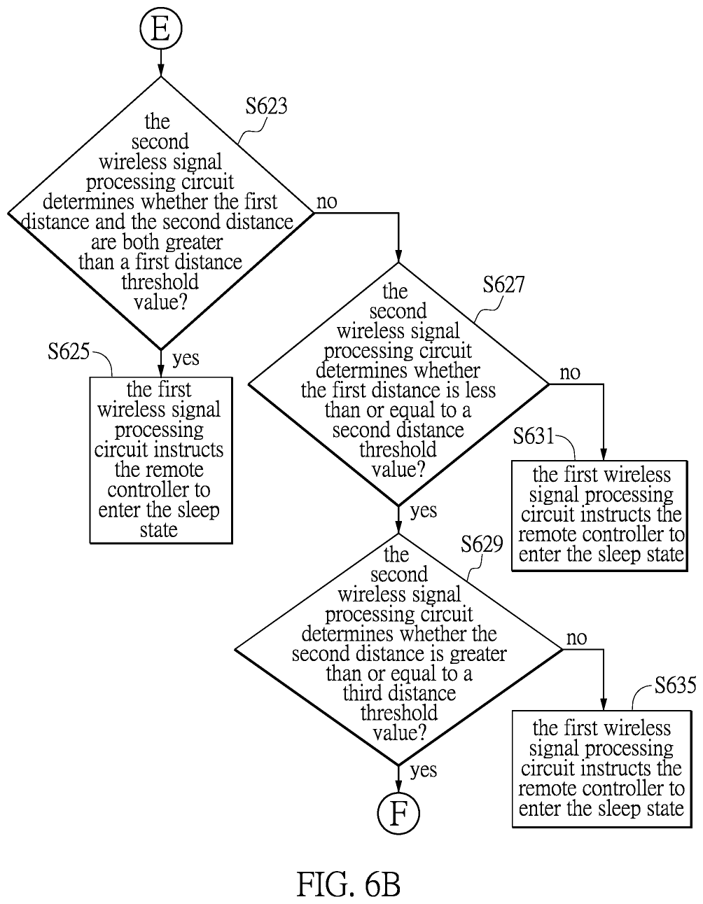

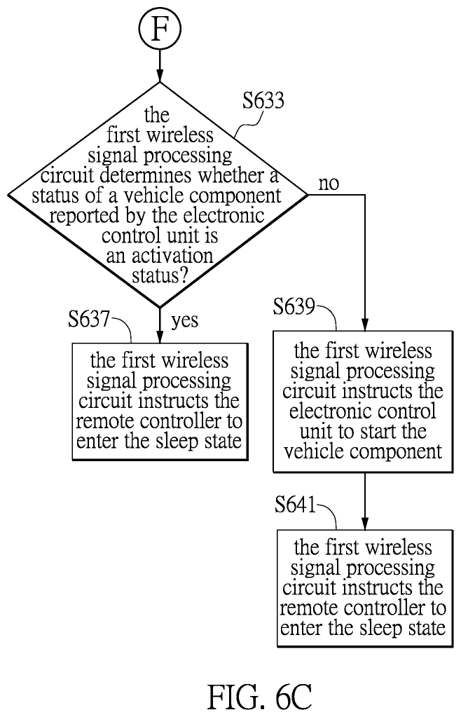

FIG. 6A to FIG. 6C are flowcharts of the operation method of the vehicle remote control system according to a fourth embodiment of the present disclosure. The operation method of FIG. 6A to FIG. 6C can be implemented by the vehicle remote control system of FIG. 4, but is not limited thereto.

Referring to FIG. 6A, in step S601, the remote controller R is moved and switched from the sleep state to the wake-up state. In step S603, the BLUETOOTH® antenna 44 receives the first radio frequency signal sent by the remote controller R. In step S605, the first wireless signal processing circuit 42 reads the first radio frequency signal to calculate the received signal strength between the vehicle V and the remote controller R. In step S607, the first wireless signal processing circuit 42 determines whether the received signal strength is less than a strength threshold value. When the received signal strength is less than the strength threshold value, step S607 is followed by step S609. When the received signal strength is greater than or equal to the strength threshold value, step S607 is followed by step S611.

In step S609, the first wireless signal processing circuit 42 instructs the remote controller R to enter the sleep state. In step S611, the first wireless signal processing circuit 42 enables the second wireless signal processing circuit 43. In step S613, the first antenna 46 receives the second radio frequency signal sent by the remote controller R.

In step S615, the second wireless signal processing circuit 43 reads the second radio frequency signal to calculate the first distance between the remote controller R and the vehicle V. In step S617, the first wireless signal processing circuit 42 sends the switch instruction to the switch device 45. In step S619, the second antenna 52 receives the third radio frequency signal sent by the remote controller R. In step S621, the second wireless signal processing circuit 43 reads the third radio frequency signal to calculate the second distance between the remote controller R and the vehicle V.

Referring to FIG. 6B, in step S623, the second wireless signal processing circuit 43 determines whether the first distance and the second distance are both greater than a first distance threshold value. When both of the first distance and the second distance are greater than the first distance threshold value, step S623 is followed by step S625. When at least one of the first distance and the second distance is less than or equal to the first distance threshold value, step S623 is followed by step S627.

In step S625, the first wireless signal processing circuit 42 instructs the remote controller R to enter the sleep state. In step S627, the second wireless signal processing circuit 43 determines whether the first distance is less than or equal to a second distance threshold value. When the first distance is less than or equal to the second distance threshold value, step S627 is followed by step S629. When the first distance is greater than the second distance threshold value, step S627 is followed by step S631.

In step S629, the second wireless signal processing circuit 43 determines whether the second distance is greater than or equal to a third distance threshold value. Here, the third distance threshold value is greater than the first distance threshold value, and the first distance threshold value is greater than the second distance threshold value. In step S631, the first wireless signal processing circuit 42 instructs the remote controller R to enter the sleep state.

When the second distance is greater than or equal to the third distance threshold value, step S629 is followed by step S633. When the second distance is less than the third distance threshold value, step S629 is followed by step S635.

Referring to FIG. 6B and FIG. 6C, in step S633, the first wireless signal processing circuit 42 determines whether a status of a vehicle component reported by the electronic control unit ECU is an activation status. In step S635, the first wireless signal processing circuit 42 instructs the remote controller R to enter the sleep state.

Referring to FIG. 6C, when the first wireless signal processing circuit 42 determines that the status of the vehicle component is the activation status, step S633 is followed by step S637. When the first wireless signal processing circuit 42 determines that the status of the vehicle component is not the activation status, step S633 is followed by step S639. In step S637, the first wireless signal processing circuit 42 instructs the remote controller R to enter the sleep state. In step S639, the first wireless signal processing circuit 42 instructs the electronic control unit ECU to start the vehicle component. Then, step S639 is followed by step S641. In step S641, the first wireless signal processing circuit 42 instructs the remote controller R to enter the sleep state.

Regarding the operation method of FIG. 6A to FIG. 6C, two practical examples are illustrated below. In a first practical example, the first BLUETOOTH® antenna and the first ultra-wideband antenna are disposed in the head area of the motorcycle, the second ultra-wideband antenna is disposed in the rear area of the motorcycle, and the remote controller R is placed in the front pocket of the user. When the first BLUETOOTH® antenna receives the first radio frequency signal from the remote controller at the first time point, the BLUETOOTH® communication circuit reads the first radio frequency signal to calculate the received signal strength between the motorcycle and the remote controller. The BLUETOOTH® communication circuit determines whether the received signal strength is less than −71 dBm. When the received signal strength is less than −71 dBm, the BLUETOOTH® communication circuit instructs the remote controller to enter the sleep state. When the received signal strength is greater than or equal to −71 dBm, the BLUETOOTH® communication circuit enables the ultra-wideband communication circuit.

The first ultra-wideband antenna receives the second radio frequency signal from the remote controller at the second time point, and the ultra-wideband communication circuit reads the second radio frequency signal to calculate the first distance between the motorcycle and the remote controller. The BLUETOOTH® communication circuit sends the switch instruction to the switch device. The second ultra-wideband antenna receives the third radio frequency signal from the remote controller at the third time point, and the ultra-wideband communication circuit reads the third radio frequency signal to calculate the second distance between the motorcycle and the remote controller. The ultra-wideband communication circuit determines whether the first distance and the second distance are both greater than 91 cm. When both of the first distance and the second distance are greater than 91 cm, the BLUETOOTH® communication circuit instructs the remote controller to enter the sleep state. When at least one of the first distance and the second distance is less than or equal to 91 cm, the ultra-wideband communication circuit further determines whether the first distance is less than or equal to 70 cm. When the first distance is less than or equal to 70 cm, the ultra-wideband communication circuit further determines whether the second distance is greater than or equal to 170 cm. When the first distance is greater than 70 cm, the BLUETOOTH® communication circuit instructs the remote controller R to enter the sleep state.

When the second distance is greater than or equal to 170 cm, the BLUETOOTH® communication circuit determines whether the engine is started. When the second distance is less than 170 cm, the BLUETOOTH® communication circuit instructs the remote control R to enter the sleep state.

A second practical example is different from the first practical example in that the remote controller R is located in the back pocket or the backpack of the user. When at least one of the first distance and the second distance is less than or equal to 91 cm, the ultra-wideband communication circuit further determines whether the first distance is greater than or equal to 170 cm. When the first distance is greater than or equal to 170 cm, the ultra-wideband communication circuit further determines whether the second distance is less than or equal to 70 cm. When the first distance is less than 170 cm, the BLUETOOTH® communication circuit instructs the remote controller R to enter the sleep state. When the second distance is less than or equal to 70 cm, the BLUETOOTH® communication circuit determines whether the power switch P or the engine E is started. When the second distance is greater than 70 cm, the BLUETOOTH® communication circuit instructs the remote controller R to enter the sleep state. The first and the second practical examples can be used to determine whether the user is located between two antennas. In other words, the first and the second practical examples can be used to determine whether the user sits on the seat of the motorcycle. When one of the antennas is blocked by the user's body, the distance corresponding to the blocked antenna at least increases 100 cm.

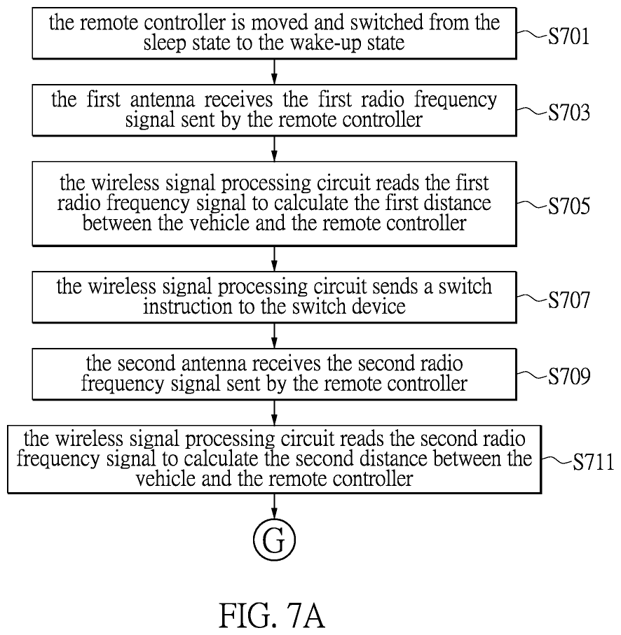

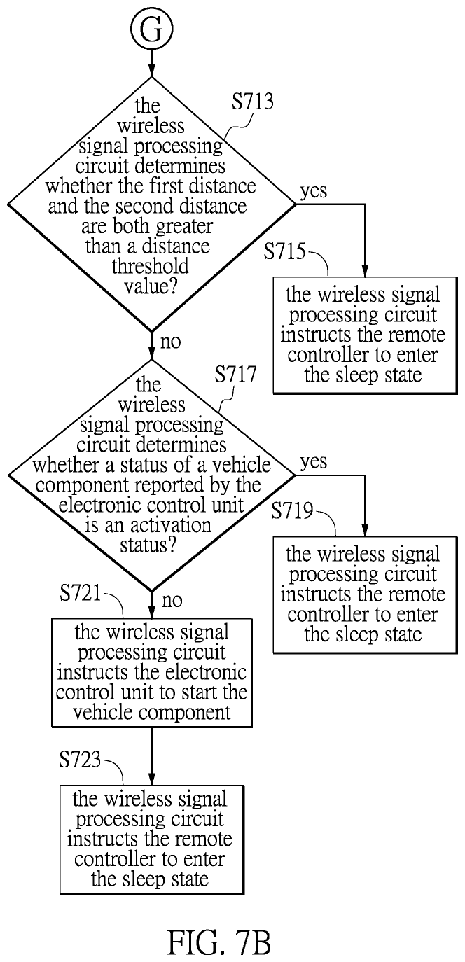

FIG. 7A and FIG. 7B are flowcharts of the operation method of the vehicle remote control system according to a fifth embodiment of the present disclosure. Referring to FIG. 7A, in step S701, the remote controller R is moved and switched from the sleep state to the wake-up state. In step S703, the first antenna 17 receives the first radio frequency signal sent by the remote controller R, and the first antenna 17 is the first ultra-wideband antenna. In step S705, the wireless signal processing circuit 13 reads the first radio frequency signal to calculate the first distance between the vehicle V and the remote controller R, and the wireless signal processing circuit 13 is the ultra-wideband communication circuit. In step S707, the wireless signal processing circuit 13 sends a switch instruction to the switch device 15. In step S709, the second antenna 23 receives the second radio frequency signal sent by the remote controller R, and the second antenna 19 is the second ultra-wideband antenna. In step S711, the wireless signal processing circuit 13 reads the second radio frequency signal to calculate the second distance between the vehicle V and the remote controller R.

Referring to FIG. 7B, in step S713, the wireless signal processing circuit 13 determines whether the first distance and the second distance are both greater than a distance threshold value. When both of the first distance and the second distance are greater than the distance threshold value, step S713 is followed by step S715. When at least one of the first distance and the second distance is less than or equal to the distance threshold value, step S713 is followed by step S717.

In step S715, the wireless signal processing circuit 13 instructs the remote controller R to enter the sleep state. In step S717, the wireless signal processing circuit 13 determines whether a status of a vehicle component reported by the electronic control unit ECU is an activation status.

When the wireless signal processing circuit 13 determines that the status of the vehicle component is the activation status, step S717 is followed by step S719. When the wireless signal processing circuit 13 determines that the status of the vehicle component is not the activation status, step S717 is followed by step S721. In step S719, the wireless signal processing circuit 13 instructs the remote controller R to enter the sleep state. In step S721, the wireless signal processing circuit 13 instructs the electronic control unit ECU to start the vehicle component. Then, step S721 is followed by step S723. In step S723, the wireless signal processing circuit 13 instructs the remote controller R to enter the sleep state.

### Beneficial Effects of the Embodiments

In conclusion, in the vehicle remote control system and the operation method thereof provided by the present disclosure, a signal dead zone of the remote controller can be reduced by at least two antennas installed on the vehicle, and the wireless signal processing circuit is prevented from misjudging a signal transmitted from the remote controller.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A vehicle remote control system, which is adapted to a remote controller and a vehicle, the vehicle remote control system comprising:
a wireless signal processing circuit;
a first antenna;
a switch device connected to the first antenna and the wireless signal processing circuit;
a signal transmission line, wherein a first end of the signal transmission line is electrically connected to the switch device;
a second antenna electrically connected to a second end of the signal transmission line;
wherein, according to a switch instruction of the wireless signal processing circuit, the switch device allows one of the first antenna and the second antenna to be used in a switching manner; wherein the wireless signal processing circuit obtains first state information between the remote controller and the vehicle by the first antenna, and obtains second state information between the remote controller and the vehicle by the second antenna.

2. The vehicle remote control system according to claim 1, wherein, when the remote controller is located between the first antenna and the second antenna and at least one of the first state information and the second state information complies with a threshold standard, the wireless signal processing circuit determines a status reported by an electronic control unit of the vehicle.

3. The vehicle remote control system according to claim 2, wherein the status is a status of a power switch of the vehicle or a status of an engine of the vehicle.

4. The vehicle remote control system according to claim 1, wherein, when the switch device is in a first state, a first signal transmission path between the first antenna and the wireless signal processing circuit is in an conductive state, a second transmission path between the second antenna and the wireless signal processing circuit is in a non-conductive state, and the wireless signal processing circuit reads a first signal of the remote controller received by the first antenna to calculate the first state information; wherein, when the switch device is in a second state, the first signal transmission path is in the non-conductive state, the second signal transmission path is in the conductive state, and the wireless signal processing circuit reads a second signal of the remote controller received by the second antenna to calculate the second state information.

5. The vehicle remote control system according to claim 1, wherein the wireless signal processing circuit is a BLUETOOTH® communication circuit, the first state information is a first received signal strength between the remote controller and the vehicle, and the second state information is a second received signal strength between the remote controller and the vehicle; wherein, when the BLUETOOTH® communication circuit determines that the first received signal strength and the second received signal strength are both less than a strength threshold value, the BLUETOOTH® communication circuit instructs the remote controller to enter a sleep state; wherein, when the BLUETOOTH® communication circuit determines that at least one of the first received signal strength and the second received signal strength is greater than or equal to the strength threshold, the BLUETOOTH® communication circuit determines a status reported by an electronic control unit of the vehicle.

6. The vehicle remote control system according to claim 1, wherein the vehicle is a motorcycle, and the first antenna and the second antenna are respectively located at a head area and a rear area of the motorcycle.

7. The vehicle remote control system according to claim 1, wherein the wireless signal processing circuit is an ultra-wideband communication circuit, the first state information is a first distance between the remote controller and the vehicle, and the second state information is a second distance between the remote controller and the vehicle; wherein, when the ultra-wideband communication circuit determines that the first distance and the second distance are both greater than a distance threshold value, the ultra-wideband communication circuit instructs the remote controller to enter a sleep state; wherein, when the ultra-wideband communication circuit determines that at least one of the first distance and the second distance is less than or equal to the distance threshold, the ultra-wideband communication circuit determines a status reported by an electronic control unit of the vehicle.

8. The vehicle remote control system according to claim 7, further comprising a BLUETOOTH® communication circuit and a BLUETOOTH® antenna, wherein the BLUETOOTH® communication circuit is connected to the BLUETOOTH® antenna, the ultra-wideband communication circuit, and the switch device; wherein, when the BLUETOOTH® communication circuit determines that a received signal strength between the remote controller and the vehicle is greater than a strength threshold value, the BLUETOOTH® communication circuit enables the ultra-wideband communication circuit.

9. An operation method of a vehicle remote control system, which is adapted to a remote controller and a vehicle, the operation method comprising:
obtaining, by a first antenna, a first signal of the remote controller;
reading, by a wireless signal processing circuit, the first signal to calculate first state information between the remote controller and the vehicle;
performing, by a switch device, an antenna switching action;
obtaining, by a second antenna, a second signal of the remote controller; and
reading, by the wireless signal processing circuit, the second signal to calculate second state information between the remote controller and the vehicle.

10. The operation method according to claim 9, wherein, when the remote controller is located between the first antenna and the second antenna and at least one of the first state information and the second state information complies with a threshold standard, the wireless signal processing circuit determines a status reported by an electronic control unit of the vehicle.

11. The operation method according to claim 10, wherein the status is a status of a power switch of the vehicle or a status of an engine of the vehicle.

12. The operation method according to claim 9, wherein the vehicle is a motorcycle, and the first antenna and the second antenna are respectively located at a head area and a rear area of the motorcycle.

13. The operation method according to claim 9, wherein the antenna switching action includes: switching a first signal transmission path between the first antenna and the wireless signal processing circuit to be in a non-conductive state; and switching a second signal transmission path between the second antenna and the wireless signal processing circuit to be in a conductive state.

14. The operation method according to claim 9, wherein the wireless signal processing circuit is a BLUETOOTH® communication circuit, the first state information is a first received signal strength, and the second state information is a second received signal strength; wherein the operation method further comprises: determining, by the BLUETOOTH® communication circuit, whether the first received signal strength and the second received signal strength are both less than a strength threshold value; instructing, by the BLUETOOTH® communication circuit, the remote controller to enter a sleep state when the first received signal strength and the second received signal strength are both less than the strength threshold; and determining, by the BLUETOOTH® communication circuit, a status reported by an electronic control unit of the vehicle when at least one of the first received signal strength and the second received signal strength is greater than or equal to the strength threshold value.

15. The operation method according to claim 9, wherein the wireless signal processing circuit is an ultra-wideband communication circuit, the first state information is a first distance, and the second state information is a second distance; wherein the operation method further comprises: determining, by the ultra-wideband communication circuit, whether the first distance and the second distance are both greater than a distance threshold value; instructing, by the ultra-wideband communication circuit, the remote controller to enter a sleep state when the first distance and the second distance are both greater than the distance threshold value; and determining, by the ultra-wideband communication circuit, a status reported by an electronic control unit of the vehicle when at least one of the first distance and the second distance is less than or equal to the distance threshold value.

16. The operation method according to claim 9, wherein the wireless signal processing circuit is a BLUETOOTH® communication circuit, the first state information is a first received signal strength, and the second state information is a second received signal strength; wherein the operation method further comprises: determining, by the BLUETOOTH® communication circuit, whether the first received signal strength and the second received signal strength are both less than a first strength threshold value; instructing, by the BLUETOOTH® communication circuit, the remote controller to enter a sleep state when the first received signal strength and the second received signal strength are both less than the first strength threshold value; determining, by the BLUETOOTH® communication circuit, whether the first received signal strength is less than or equal to a second strength threshold value and whether the second received signal strength is greater than or equal to a third strength threshold value when at least one of the first received signal strength and the second received signal strength is greater than or equal to the first strength threshold value; and determining, by the BLUETOOTH® communication circuit, a status reported by an electronic control unit of the vehicle when the first received signal strength is less than or equal to the second strength threshold value and the second received signal strength is greater than or equal to the third strength threshold value; wherein the third strength threshold value is greater than the first strength threshold value and the first strength threshold value is greater than the second strength threshold value.

17. The operation method according to claim 9, wherein the wireless signal processing circuit is an ultra-wideband communication circuit, the first state information is a first distance, and the second state information is a second distance; wherein the operation method further comprises: determining, by the ultra-wideband communication circuit, whether the first distance and the second distance are both greater than a first distance threshold value; instructing, by the ultra-wideband communication circuit, the remote controller to enter a sleep state when the first distance and the second distance are both greater than the first distance threshold value; determining, by the ultra-wideband communication circuit, whether the first distance is less than or equal to a second distance threshold value and whether the second distance is greater than or equal to a third distance threshold value when at least one of the first distance and the second distance is less than or equal to the first distance threshold; and determining, by a BLUETOOTH® communication circuit, a status reported by an electronic control unit of the vehicle when the first distance is less than or equal to the second distance threshold and the second distance is greater than or equal to the third distance threshold; wherein the third distance threshold value is greater than the first distance threshold value and the first distance threshold value is greater than the second distance threshold value.
